(19) United States
(12) Patent Application Publication
(10) Pub. No.: US 2020/0033056 A1
(43) Pub. Date: Jan. 30, 2020

(54) INFRARED RADIATION DEVICE

(71) Applicant: NGK INSULATORS, LTD., Nagoya-City (JP)

(72) Inventor: Michiro AOKI, Nagoya-City (JP)

(73) Assignee: NGK INSULATORS, LTD., Nagoya-City (JP)

(21) Appl. No.: 16/515,289

(22) Filed: Jul. 18, 2019

(30) Foreign Application Priority Data
Jul. 26, 2018 (JP) 2018-140387

(51) Int. Cl. F26B 3/30; H05B 3/12; H05B 3/26; H05B 3/28; G02B 1/00; F28F 13/18

(52) U.S. Cl. CPC F26B 3/30; H05B 3/12; H05B 3/265; F28F 2013/001; G02B 1/002; F28F 13/18; H05B 2203/032; H05B 3/283

(57) ABSTRACT

An infrared radiation device includes a radiation portion including a heating portion and a metamaterial structure capable of emitting infrared radiation having a peak wavelength of a non-Planck distribution from a radiation surface when thermal energy is supplied from the heating portion; a reflecting portion that surrounds the radiation portion and reflects the infrared radiation emitted from the metamaterial structure; and an emitting portion having an incident surface on which the infrared radiation reflected by the reflecting portion is incident and an emission surface through which infrared radiation incident on the incident surface is emitted to outside, the emission surface having an area less than an area of the radiation surface.

### BACKGROUND OF THE INVENTION

### 1. Field of the Invention

The present invention relates to an infrared radiation device.

### 2. Description of the Related Art

Infrared radiation devices including metamaterial structures have been known. PTL 1, for example, describes a radiation device including a heat source, a metamaterial structure layer provided on a front-surface side of the heat source, and a back metal layer provided on a back-surface side of the heat source. The metamaterial structure layer emits thermal energy input from the heat source as radiation energy having a specific wavelength range.

### CITATION LIST

### Patent Literature

PTL 1: WO 2017/163986 A1

### SUMMARY OF THE INVENTION

An infrared radiation device including a metamaterial structure desirably emits locally concentrated infrared radiation. However, PTL 1 does not take local infrared radiation into consideration.

The present invention has been made to solve the above-described problem, and the main object of the present invention is to provide an infrared radiation device that has a metamaterial structure and that locally emits infrared radiation to the outside.

To achieve the above-described principal object, the following configuration is employed in the present invention.

An infrared radiation device of the present invention includes a radiation portion including a heating portion and metamaterial structure capable of emitting infrared radiation having a peak wavelength of a non-Planck distribution from a radiation surface when thermal energy is supplied from the heating portion, a reflecting portion that surrounds the radiation portion and reflects the infrared radiation emitted from the metamaterial structure, and an emitting portion having an incident surface on which the infrared radiation reflected by the reflecting portion is incident and an emission surface through which infrared radiation incident on the incident surface is emitted to outside, the emission surface having an area less than an area of the radiation surface.

The infrared radiation device includes a metamaterial structure that emits infrared radiation having a peak wavelength of a non-Planck distribution. In other words, the metamaterial structure selectively emits infrared radiation in a specific wavelength range. The emitted infrared radiation is reflected by the reflecting portion disposed around the radiation portion, reaches the incident surface of the emitting portion, and is emitted from the emission surface of the emitting portion. The area of the emission surface is less than that of the radiation surface of the metamaterial structure from which infrared radiation is emitted. Thus, according to the infrared radiation device, the infrared radiation emitted from the metamaterial structure to a region around the metamaterial structure can be locally emitted from the emission surface to the outside.

In this case, the emitting portion may guide the infrared radiation incident on the incident surface to the emission surface. Alternatively, the emitting portion may guide the infrared radiation incident on the incident surface to the emission surface by reflection. The emitting portion may be a space, such as a hole or a clearance, formed in the reflecting portion. The emitting portion may include a member disposed in a hole or clearance formed in the reflecting portion.

The infrared radiation device according to the present invention may be configured such that the reflecting portion has an interior space therein, the radiation portion being disposed in the interior space, and that the interior space does not communicate with the outside. In such a case, the infrared radiation emitted from the metamaterial structure into the interior space is prevented from leaking to the outside through, for example, clearances in the reflecting portion.

In this case, the pressure in the interior space may be capable of being reduced. Accordingly, by using the infrared radiation device while the pressure in the interior space is reduced, the amount of convective heat transfer from the radiation portion to the interior space is less than that when, for example, the pressure in the interior space is a normal pressure, and the convective loss can be reduced. As a result, the energy efficiency of the infrared radiation device can be increased.

In the infrared radiation device according to the present invention, the emitting portion guides the infrared radiation to the emission surface by total reflection. In such a case, the infrared radiation from the metamaterial structure can be prevented from leaking to the outside through a region other than the emission surface of the emitting portion.

The infrared radiation device according to the present invention may be configured such that the emitting portion includes a main portion and a reflective layer, the main portion having the incident surface and the emission surface and guiding the infrared radiation to the emission surface by total reflection, the reflective layer being disposed on an outer peripheral surface of the main portion extending in a direction from the incident surface to the emission surface at least in a region adjacent to the incident surface and reflecting the infrared radiation toward the main portion. In such a case, the emitting portion guides the infrared radiation to the emission surface by total reflection. Therefore, the infrared radiation emitted from the metamaterial structure can be prevented from leaking to the outside through a region other than the emission surface of the emitting portion. The reflective layer reflects the infrared radiation toward the main portion. Therefore, even when there is infrared radiation that passes through the main portion without total reflection, the reflective layer prevents such infrared radiation from leaking to the outside. In particular, part of the infrared radiation is incident on the reflective surface of the main portion at the incident angle less than the critical angle in the region of the outer peripheral surface of the main portion adjacent to the incident surface, and easily leaks to the outside through the main portion without being totally reflected. Therefore, leakage of the infrared radiation can be effectively prevented by arranging the reflective layer in the region adjacent to the incident surface.

In this case, the emitting portion may be connected to the reflecting portion at a side of the emitting portion adjacent to the incident surface, and the region in which the reflective layer is disposed may include connecting portion of the outer peripheral surface of the main portion, the connecting portion being connected to the reflecting portion. Although the infrared radiation easily leaks to the outside through the connecting portion, the infrared radiation can be prevented from leaking to the outside since the reflective layer is provided on the connecting portion.

In the infrared radiation device according to the present invention, the metamaterial structure may include a first metamaterial structure that is disposed on a first-surface side of the heating portion and emits the infrared radiation from a first radiation surface and a second metamaterial structure that is disposed on a second-surface side of the heating portion and emits the infrared radiation from a second radiation surface, the second-surface side being opposite to the first-surface side. The emission surface may have an area less than an area of at least one of the first radiation surface and the second radiation surface. Accordingly, the radiation portion is capable of selectively emitting infrared radiation in a specific wavelength range from both the first-surface side and the second-surface side of the radiation portion. Therefore, compared to the case in which the second metamaterial structure is not provided on the second-surface side of the heating portion, emission of infrared radiation at unnecessary wavelengths other than the specific wavelength range from the second-surface side can be prevented, and loss of thermal energy from the second surface can be reduced.

In the infrared radiation device according to the present invention, the metamaterial structure may include a first conductor layer, a dielectric layer joined to the first conductor layer, and a second conductor layer in that order from the heating portion, the second conductor layer including a plurality of individual conductor layers that are each joined to the dielectric layer and that are periodically arranged with gaps therebetween.

In the infrared radiation device according to the present invention, the metamaterial structure may have a plurality of microcavities, at least surfaces of which are formed of a conductor and which are periodically arranged with gaps therebetween.

### BRIEF DESCRIPTION OF THE DRAWINGS

FIG. 1 shows sectional views of an infrared radiation device 10.

FIG. 2 is a sectional view of the infrared radiation device 10.

FIG. 3 is a partial bottom view of a first metamaterial structure 30a.

FIG. 4 is a sectional view of an infrared radiation device 10 according to a modification.

FIG. 5 is a sectional view of an infrared radiation device 10 according to a modification.

FIG. 6 is a sectional view of an infrared radiation device 10 according to a modification.

FIG. 7 is a partial sectional view of a radiation portion 11 according to a modification.

FIG. 8 is a partial bottom perspective view of a first metamaterial structure 30a according to a modification.

### DETAILED DESCRIPTION OF THE INVENTION

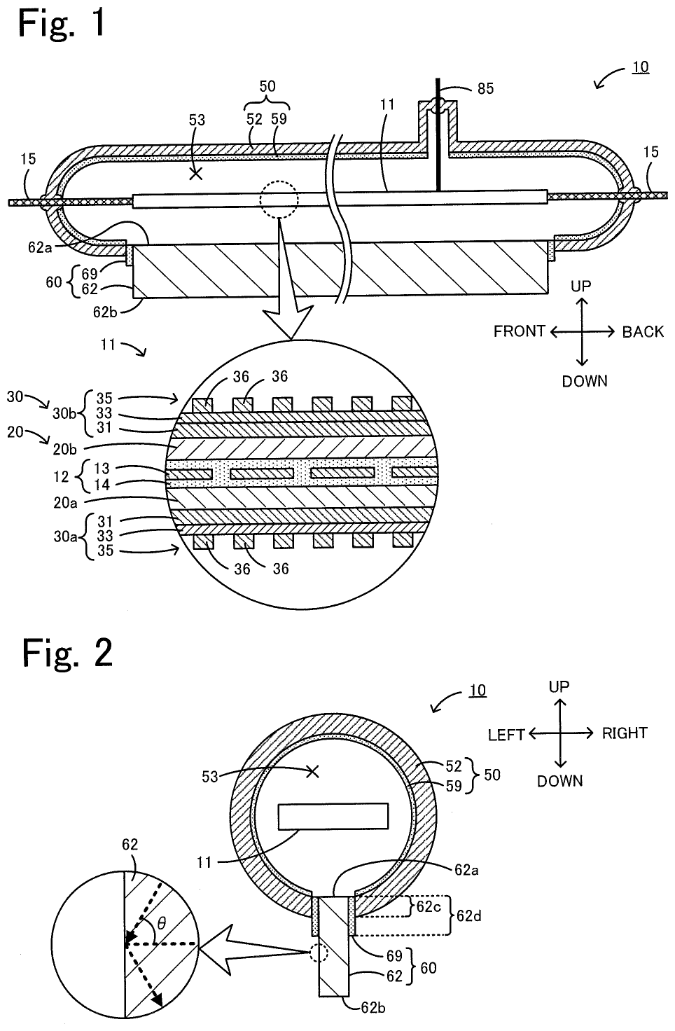

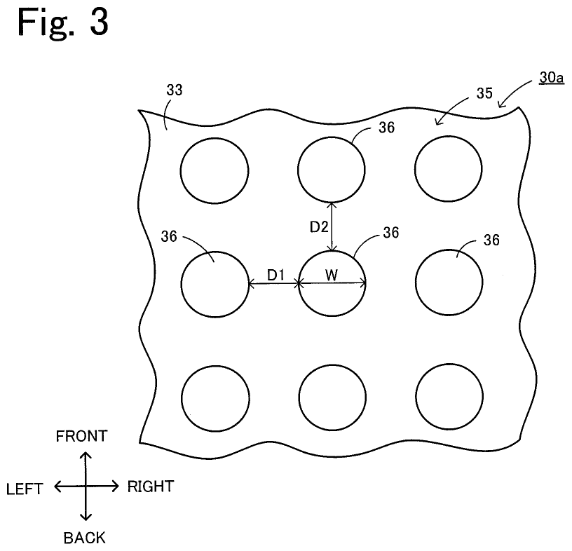

An embodiment of the present invention will now be described with reference to the drawings. FIGS. 1 and 2 are sectional views of an infrared radiation device 10 according to an embodiment of the present invention. FIG. 3 is a partial bottom view of a first metamaterial structure 30a. FIG. 1 is a vertical sectional view of the infrared radiation device 10 taken along an axial direction (front-back direction in this example). FIG. 2 is a sectional view of the infrared radiation device 10 taken along a line perpendicular to the axial direction. In the present embodiment, an up-down direction, a front-back direction, and a left-right direction are defined as illustrated in FIGS. 1 to 3. The infrared radiation device 10 includes a radiation portion 11, a reflecting portion 50, an emitting portion 60, and a thermocouple 85. The infrared radiation device 10 emits infrared radiation toward an object (not shown) disposed therebelow.

The radiation portion 11 is disposed in an interior space 53 of the reflecting portion 50. The radiation portion 11 is flat-plate-shaped. As illustrated in the enlarged view shown in FIG. 1, the radiation portion 11 includes a heating portion 12, first and second support substrates 20a and 20b, and first and second metamaterial structures 30a and 30b.

The heating portion 12 is configured as a so-called flat heater, and includes a heating element 13 including a line-shaped member bent in a zig-zag manner and a protective member 14 composed of an insulator disposed in contact with the heating element 13 to cover the periphery of the heating element 13. The material of the heating element 13 may be, for example, W, Mo, Ta, Fe—Cr—Al alloy, or Ni—Cr alloy. In the present embodiment, the heating element 13 is made of Kanthal (trademark: alloy containing iron, chromium, and aluminum). The material of the protective member 14 may be, for example, an insulating resin, such as polyimide, or a ceramic. Rod-shaped conductors 15, which are electrically connected to the heating element 13, are attached to both ends of the radiation portion 11 in the longitudinal direction (front-back direction in this example). The rod-shaped conductors 15 extend to the outside from both ends of an outer tube 52 of the reflecting portion 50 in the axial direction. Electric power can be supplied from the outside to the heating element 13 through the rod-shaped conductors 15. The rod-shaped conductors 15 also have a function of supporting the radiation portion 11 in the reflecting portion 50. The material of the rod-shaped conductors 15 is Mo in this example. The heating portion 12 may instead be a flat heater configured such that a ribbon-shaped heating element is wound around an insulator.

The first and second support substrates 20a and 20b are flat-plate-shaped members. The first support substrate 20a is disposed on a first-surface side (bottom-surface side in this example) of the heating portion 12. The second support substrate 20b is disposed on a second-surface side (top-surface side in this example) of the heating portion 12. The first support substrate 20a and the second support substrate 20b are generically referred to as support substrates 20. The support substrates 20 support the heating portion 12 and the first and second metamaterial structures 30a and 30b. The support substrates 20 may be composed of, for example, a material such as a Si wafer or glass whose surface can be easily maintained smooth, which is highly heat resistant, and which is not easily thermally warped. In the present embodiment, the support substrates 20 are composed of quartz glass. The first and second support substrates 20a and 20b may either be in contact with the bottom and top surfaces of the heating portion 12 as in the present embodiment, or be spaced and separated from the heating portion 12 in the up-down direction. When the support substrates 20 are in contact with the heating portion 12, the support substrates 20 and the heating portion 12 may be joined together.

The first and second metamaterial structures 30a and 30b are plate-shaped members. The first metamaterial structure 30a is disposed on the first-surface side (bottom-surface side in this example) of the heating portion 12 and below the first support substrate 20a. The second metamaterial structure 30b is disposed on the second-surface side (top-surface side in this example) of the heating portion 12 and above the second support substrate 20b. The first metamaterial structure 30a and the second metamaterial structure 30b are generically referred to as metamaterial structure 30. The first metamaterial structure 30a may be bonded to the bottom surface of the first support substrate 20a either directly or with an adhesive layer (not shown) provided therebetween. Similarly, the second metamaterial structure 30b may be bonded to the top surface of the second support substrate 20b either directly or with an adhesive layer (not shown) provided therebetween. The first metamaterial structure 30a emits infrared radiation mainly downward from the bottom surface (example of first radiation surface) thereof. The second metamaterial structure 30b emits infrared radiation mainly upward from the top surface (example of second radiation surface) thereof. As illustrated in FIG. 1, the first metamaterial structure 30a and the second metamaterial structure 30b have identical structural elements, and are symmetrical to each other about a plane perpendicular to the up-down direction in the present embodiment. In the following description, the first metamaterial structure 30a will be described. Components of the second metamaterial structure 30b are denoted by the same reference numerals in FIG. 1, and detailed description thereof will be omitted.

The first metamaterial structure 30a includes a first conductor layer 31, a dielectric layer 33, and a second conductor layer 35, which includes a plurality of individual conductor layers 36, in that order in a downward direction from the heating element 13. This structure is referred to as a metal-insulator-metal (MIM) structure. The layers of the first metamaterial structure 30a may be joined together either directly or with adhesive layers provided therebetween. Bottom exposed portions of the individual conductor layers 36 and the dielectric layer 33 may be coated with an oxidation resistant layer (not shown and made of, for example, alumina).

The first conductor layer 31 is a flat-plate-shaped member joined to the first support substrate 20a at a side (bottom side) opposite to the side at which the heating element 13 is provided. The material of the first conductor layer 31 may be, for example, a conductor (electrical conductor), such as a metal. Examples of the metal include gold, aluminum (Al), and molybdenum (Mo). In the present embodiment, the material of the first conductor layer 31 is gold. The first conductor layer 31 is joined to the first support substrate 20a with an adhesive layer (not shown) provided therebetween. The material of the adhesive layer may be, for example, chromium (Cr), titanium (Ti), or ruthenium (Ru). The first conductor layer 31 and the first support substrate 20a may instead be joined directly to each other.

The dielectric layer 33 is a flat-plate-shaped member joined to the first conductor layer 31 at a side (bottom side) opposite to the side at which the heating element 13 is provided. The dielectric layer 33 is disposed between the first conductor layer 31 and the second conductor layer 35. The material of the dielectric layer 33 may be, for example, alumina (Al₂O₃) or silica (SiO₂). In the present embodiment, the material of the dielectric layer 33 is alumina.

The second conductor layer 35 is a layer composed of a conductor, and has a periodic structure in directions along the bottom surface of the dielectric layer 33 (front-back and left-right directions). More specifically, the second conductor layer 35 includes the individual conductor layers 36, and the individual conductor layers 36 are arranged with gaps therebetween in the directions along the bottom surface of the dielectric layer 33 (front-back and left-right directions) to form the periodic structure (see FIG. 3). The individual conductor layers 36 are arranged at equal intervals and separated from each other by a gap D1 in the left-right direction (first direction). The individual conductor layers 36 are also arranged at equal intervals and separated from each other by a gap D2 in the front-back direction (second direction) orthogonal to the left-right direction. Thus, the individual conductor layers 36 are arranged in a grid pattern. Although the individual conductor layers 36 are arranged in a rectangular grid pattern in the present embodiment as illustrated in FIG. 3, the individual conductor layers 36 may instead be arranged in, for example, a hexagonal grid pattern such that the individual conductor layers 36 are at the vertices of regular triangles. Each of the individual conductor layers 36 is circular in bottom view, and has a cylindrical shape with a thickness h (height in the up-down direction) less than a diameter W thereof. The period of the periodic structure of the second conductor layer 35 is Λ1=D1+W in the horizontal direction and Λ2=D2+W in the vertical direction. In the present embodiment, D1=D2. Therefore, Λ1=Λ2. The material of the second conductor layer 35 (individual conductor layers 36) may be a conductor, such as a metal, and may be a material similar to that of the above-described first conductor layer 31. At least one of the first conductor layer 31 and the second conductor layer 35 may be made of a metal. In the present embodiment, the material of the second conductor layer 35 is gold, which is the same as the material of the first conductor layer 31.

As described above, the first metamaterial structure 30a includes the first conductor layer 31, the second conductor layer 35 (individual conductor layers 36) having the periodic structure, and the dielectric layer 33 disposed between the first conductor layer 31 and the second conductor layer 35. This configuration enables the first metamaterial structure 30a to emit infrared radiation having a peak wavelength of a non-Planck distribution when thermal energy is supplied thereto from the heating portion 12. A Planck distribution is a bell-shaped distribution having a specific peak on a graph having the horizontal axis representing the wavelength that increases toward the right and the vertical axis representing the radiation intensity. The Planck distribution is represented by a curve having a steep slope on the left side of the peak and a gentle slope on the right side of the peak. An ordinary material emits radiation in accordance with this curve (Planck's radiation curve). Non-Planck radiation (infrared radiation having a peak wavelength of a non-Planck distribution) is radiation represented by a bell-shaped curve that is sharper than that of the Planck's radiation in a range having a maximum peak at the center. More specifically, the radiation characteristics of the first metamaterial structure 30a are such that the maximum peak thereof is sharper than the peak of the Planck distribution. Here, the expression “sharper than the peak of the Planck distribution” means that “half-width (full width at half maximum (FWHM)) is smaller than that of the peak of the Planck distribution”. Accordingly, the first metamaterial structure 30a functions as a metamaterial emitter having such characteristics as to selectively emit infrared radiation having a specific wavelength in the entire infrared wavelength range (0.7 μm to 1000 μm). It is considered that these characteristics derive from a resonance phenomenon that can be explained by a magnetic polariton. The magnetic polariton is a resonance phenomenon in which antiparallel currents are excited in two upper and lower conductors (first conductor layer 31 and second conductor layer 35) and in which a strong magnetic field confinement effect is generated in a dielectric (dielectric layer 33) between the conductors. Accordingly, a locally strong electric field vibration is excited in the first conductor layer 31 and the individual conductor layers 36 of the first metamaterial structure 30a, and this serves as a source of infrared radiation. The infrared radiation is emitted into the ambient environment (especially downward in this embodiment). According to the first metamaterial structure 30a, the resonant wavelength can be adjusted by changing the materials of the first conductor layer 31, the dielectric layer 33, and the second conductor layer 35 and adjusting the shape and the periodic structure of the individual conductor layers 36. Thus, the first conductor layer 31 and the individual conductor layers 36 of the first metamaterial structure 30a emit infrared radiation such that the infrared emissivity is high at a specific wavelength. In other words, the first metamaterial structure 30a has such characteristics as to emit infrared radiation having a sharp maximum peak with a relatively small half-width and a relatively high emissivity. Although D1=D2 in the present embodiment, the gaps D1 and D2 may differ from each other. This also applies to the periods Λ1 and Λ2. The half-width can be controlled by changing the periods Λ1 and Λ2. The wavelength at the above-described maximum peak of the predetermined radiation characteristics of the first metamaterial structure 30a may be in the range of greater than or equal to 6 μm and less than or equal to 7 μm, or in the range of greater than or equal to 2.5 μm and less than or equal to 3.5 μm. The infrared emissivity of the first metamaterial structure 30a in the wavelength range other than the wavelength range from the rising edge to the falling edge of the maximum peak is preferably less than or equal to 0.2. The first metamaterial structure 30a is preferably configured such that the half-width of the maximum peak is less than or equal to 1.0 μm. The radiation characteristics of the first metamaterial structure 30a may be substantially symmetrical about a vertical line that passes through the maximum peak. The height of the maximum peak (maximum radiation intensity) of the first metamaterial structure 30a does not exceed the height of the Planck's radiation curve.

The above-described first metamaterial structure 30a may be formed by, for example, the following method. First, an adhesive layer and the first conductor layer 31 are formed in that order on a surface (bottom surface in FIG. 1) of the first support substrate 20a by sputtering. Next, the dielectric layer 33 is formed on a surface (bottom surface in FIG. 1) of the first conductor layer 31 by the atomic layer deposition (ALD) method. Subsequently, a predetermined resist pattern is formed on a surface (bottom surface in FIG. 1) of the dielectric layer 33, and then a layer made of the material of the second conductor layer 35 is formed by helicon sputtering. Then, the resist pattern is removed so that the second conductor layer 35 (individual conductor layers 36) is formed.

The infrared radiation emitted by the first metamaterial structure 30a and the infrared radiation emitted by the second metamaterial structure 30b may have the same or similar radiation characteristics. For example, the maximum peak of the infrared radiation emitted by the second metamaterial structure 30b may be the same as or close to the maximum peak of the infrared radiation emitted by the first metamaterial structure 30a. More specifically, the difference between peak wavelengths of maximum peaks of the infrared radiation emitted by the first metamaterial structure 30a and the infrared radiation emitted by the second metamaterial structure 30b may be less than or equal to 0.5 μm. The wavelength range of the full width at half maximum of the maximum peak (region of full width at half maximum) of the first metamaterial structure 30a and that of the second metamaterial structure 30b may overlap at least partially or by half or more. In the present embodiment, the first and second metamaterial structures 30a and 30b have the same D1, D2, and W, and emit infrared radiation having substantially the same radiation characteristics.

The thermocouple 85, which is an example of a temperature sensor that measures the temperature of the surface of the radiation portion 11, extends from the surface of the radiation portion 11 to the outside through the outer tube 52.

The reflecting portion 50 includes the outer tube 52 that surrounds the radiation portion 11 and a reflective layer 59 that reflects the infrared radiation emitted from the radiation portion 11. The outer tube 52 constitutes a main portion of the reflecting portion 50, and serves as a housing of the infrared radiation device 10. According to the present embodiment, the outer tube 52 is a substantially cylindrical member. The outer tube 52 has an interior space 53 therein. The radiation portion 11 is disposed in the interior space 53. The outer tube 52 entirely surrounds the radiation portion 11 in the front-back, left-right, and up-down directions except for the region in which the emitting portion 60 is exposed in the interior space 53. Thus, the interior space 53 is sealed from the outside by the outer tube 52 and the emitting portion 60, and the interior space 53 does not communicate with the outside. The material of the outer tube 52 may be, for example, metal or quartz glass. According to the present embodiment, the material of the outer tube 52 is quartz glass. The pressure in the interior space 53 is a normal pressure. The atmosphere in the interior space 53 may be an air atmosphere or an inert gas atmosphere, such as nitrogen atmosphere or argon atmosphere. Both ends of the outer tube 52 in the axial direction are curved such that the diameter of the outer tube 52 decreases toward the end, and the rod-shaped conductors 15 extend to the outside from the ends of the outer tube 52. Portions of the outer tube 52 through which the rod-shaped conductors 15 and the thermocouple 85 extend from the interior space 53 to the outside are sealed by melting the outer tube 52. These portions may instead be sealed by using a sealing material other than the outer tube 52.

The reflective layer 59 reflects the infrared radiation emitted from the metamaterial structure 30 toward the inner side of the outer tube 52. More specifically, the reflective layer 59 is capable of reflecting at least part of the infrared radiation emitted by the first and second metamaterial structures 30a and 30b that is in a wavelength range including the maximum peaks of the infrared radiation emitted by the first and second metamaterial structures 30a and 30b. The reflective layer 59 is provided on the inner peripheral surface of the outer tube 52 and substantially entirely covers the inner peripheral surface. Therefore, the reflective layer 59 reflects most of the infrared radiation emitted from the metamaterial structure 30 except for the infrared radiation that is directly emitted toward the emitting portion 60 from the first metamaterial structure 30a. The reflective layer 59 is made of a material containing an infrared ray reflecting material, such as gold, platinum, or aluminum, as the main component. In this example, the reflective layer 59 is made of gold. The reflective layer 59 may be formed on the inner peripheral surface of the outer tube 52 by a film forming method such as coating and drying, sputtering, CVD, or thermal spraying. The reflective layer 59 is preferably capable of reflecting at least part of the infrared radiation emitted by the first and second metamaterial structures 30a and 30b that is in a wavelength range including the regions of full width at half maximum of the maximum peaks of the infrared radiation emitted by the first and second metamaterial structures 30a and 30b.

The emitting portion 60 has a function of a light guide portion that guides infrared radiation reflected by the reflective layer 59 of the reflecting portion 50 to the outside, and includes a main portion 62 and a reflective layer 69. As illustrated in FIGS. 1 and 2, the main portion 62 is a plate-shaped member that is substantially rectangular parallelepiped shaped, and is disposed to project downward below the reflecting portion 50. The main portion 62 includes an incident surface 62a on which the infrared radiation reflected by the reflecting portion 50 is incident and an emission surface 62b from which the infrared radiation is emitted to the outside. According to the present embodiment, the top surface of the main portion 62 serves as the incident surface 62a, and the bottom surface serves as the emission surface 62b. The incident surface 62a and the emission surface 62b are perpendicular to the up-down direction. The incident surface 62a has a rectangular shape in top view, and the emission surface 62b has a rectangular shape in bottom view. The main portion 62 is capable of transmitting at least part of the infrared radiation emitted by the first and second metamaterial structures 30a and 30b that is in a wavelength range including the maximum peaks of the infrared radiation emitted by the first and second metamaterial structures 30a and 30b. The main portion 62 guides the infrared radiation incident on the incident surface 62a to the emission surface 62b. According to the present embodiment, the main portion 62 guides the infrared radiation that enters the main portion 62 through the incident surface 62a to the emission surface 62b by totally reflecting the infrared reflection inward at the front, back, left, and right outer peripheral surfaces of the main portion 62. A portion of the emitting portion 60 near the incident surface 62a (upper portion in this case) is inserted in an opening (hole) provided at the bottom of the reflecting portion 50. Thus, the emitting portion 60 is connected to the reflecting portion 50 by a connecting portion 62c (see FIG. 2). The connecting portion 62c is a portion of the emitting portion 60 that is inserted in the opening in the reflecting portion 50. The incident surface 62a is exposed in the interior space 53. The main portion 62 is preferably capable of transmitting at least part of the infrared radiation emitted by the first and second metamaterial structures 30a and 30b that is in a wavelength range including the regions of full width at half maximum of the maximum peaks of the infrared radiation emitted by the first and second metamaterial structures 30a and 30b. The transmittance of the main portion 62 for the infrared radiation at the peak wavelengths of the maximum peaks of the infrared radiation emitted by the first and second metamaterial structures 30a and 30b may be greater than or equal to 80%, or greater than or equal to 90%.

The area of the emission surface 62b (bottom surface of the main portion 62 in this example) is less than at least one of the area of the first radiation surface of the first metamaterial structure 30a (bottom surface of the radiation portion 11 in this example) and the area of the second radiation surface of the second metamaterial structure 30b (top surface of the radiation portion 11 in this example). According to the present embodiment, the first and second radiation surfaces have the same area, and the area of the emission surface 62b is less than that of each of the first and second radiation surfaces. In the present embodiment, the radiation portion 11 and the main portion 62 have the same length in the front-back direction, and the width of the main portion 62 in the left-right direction is less than that of the radiation portion 11. Accordingly, the area of the emission surface 62b is less than the area of the first and second radiation surfaces. The areas of the emission surface 62b, the first radiation surface, and the second radiation surface are defined as areas (apparent areas) determined without consideration of projections and recesses in the surface (for example, projections and recesses on the top and bottom surfaces of the radiation portion 11 formed by the individual conductor layers 36).

The material of the main portion 62 may be, for example, an infrared radiation transmitting material such as quartz glass (which transmits infrared radiation having a wavelength of 3.5 μm or less), transparent alumina (which transmits infrared radiation having a wavelength of 5.5 μm or less), fluorite (calcium fluoride, CaF₂, which transmits infrared radiation having a wavelength of 8 μm or less), or zinc selenide (ZnSe, which transmits infrared radiation having a wavelength of 18 μm or less). According to the present embodiment, the main portion 62 is made of quartz glass. Quartz glass transmits infrared radiation having a wavelength of 3.5 μm or less (absorbs infrared radiation having a wavelength of greater than 3.5 μm). Therefore, the radiation characteristics of the first and second metamaterial structures 30a and 30b are such that the peak wavelength of the maximum peak is 3.0 μm. The radiation characteristics can be obtained by setting, for example, the thickness of the first conductor layer 31 to 100 nm, the thickness of the dielectric layer 33 to 80 nm, the thickness of the second conductor layer 35 (individual conductor layers 36) to 60 nm, the diameter W of the individual conductor layers 36 to 0.565 μm, and the periods Λ1 and Λ2 to 4 μm.

The reflective layer 69 is a member for reflecting part of the infrared radiation emitted from the metamaterial structure 30, the part of the infrared radiation passing through the main portion 62 toward the outside through a region other than the emission surface 62b. The reflective layer 69 is capable of reflecting at least part of the infrared radiation emitted by the first and second metamaterial structures 30a and 30b that is in a wavelength range including the maximum peaks of the infrared radiation emitted by the first and second metamaterial structures 30a and 30b. The reflective layer 69 is disposed in a region 62d (see FIG. 2), which is a portion of the surface of the main portion 62. The region 62d is a portion of an outer peripheral surface (front, back, left, and right surfaces in this example) that extends in the direction from the incident surface 62a to the emission surface 62b of the main portion 62 (downward in this example). Also, the region 62d is a portion of the outer peripheral surface of the main portion 62 that is adjacent to the incident surface 62a (upper surface in this example). The region 62d includes the above-described connecting portion 62c and a portion below the connecting portion 62c. Thus, the main portion 62 is connected to the reflecting portion 50 with the reflective layer 69 provided therebetween. Similar to the reflective layer 59, the reflective layer 69 is also made of a material containing the above-described infrared ray reflecting material as the main component. In this example, the reflective layer 69 is made of gold. The reflective layer 69 may be formed on the outer peripheral surface of the main portion 62 by a film forming method such as coating and drying, sputtering, CVD, or thermal spraying. The reflective layer 69 is preferably capable of reflecting at least part of the infrared radiation emitted by the first and second metamaterial structures 30a and 30b that is in a wavelength range including the regions of full width at half maximum of the maximum peaks of the infrared radiation emitted by the first and second metamaterial structures 30a and 30b.

As described above, the front, back, left, and right outer peripheral surfaces of the main portion 62 totally reflect the infrared radiation inward. Therefore, to enable the total reflection, the main portion 62 is made of a material having a refractive index higher than that of a medium (external air and the reflective layer 69 in this example) that is in contact with the outer peripheral surfaces thereof. The above-described examples of the infrared radiation transmitting material (quartz glass, transparent alumina, fluorite, and zinc selenide) are all capable of causing total reflection.

An example of use of the above-described infrared radiation device 10 will now be described. First, a power supply (not shown) supplies electric power to the heating element 13 through the rod-shaped conductor 15. The electric power is supplied so that, for example, the temperature of the heating element 13 reaches a preset temperature (not particularly limited, and is 400° C. in this example). Energy is transferred from the heating element 13, which is heated to the predetermined temperature, into the ambient environment mainly by conduction among the three types of heat transfer: conduction, convection, and radiation. Thus, the metamaterial structure 30 is heated. As a result, the temperature of the metamaterial structure 30 increases to a predetermined temperature (for example, 390° C. in this example), so that the metamaterial structure 30 serves as radiators and emits infrared radiation. Since the metamaterial structure 30 includes the first conductor layer 31, the dielectric layer 33, and the second conductor layer 35 as described above, the radiation portion 11 emits infrared radiation having a peak wavelength of a non-Planck distribution. More specifically, the radiation portion 11 selectively emits infrared radiation in a specific wavelength range from the first and second radiation surfaces (top and bottom surfaces of the radiation portion 11) of the first and second metamaterial structures 30a and 30b on which the first conductor layers 31 and the individual conductor layers 36 are provided.

The infrared radiation emitted from the metamaterial structure 30 as described above is reflected by the reflective layer 59 of the reflecting portion 50 disposed around the radiation portion 11. Therefore, the infrared radiation reaches the incident surface 62a and hardly reaches the outer tube 52. Depending on the direction in which the infrared radiation is emitted from the metamaterial structure 30, the infrared radiation may reach the incident surface 62a after being reflected by the reflective layer 59 a plurality of times or directly reach the incident surface 62a from the first metamaterial structure 30a without being reflected. The infrared radiation that has reached the incident surface 62a passes through the main portion 62 and reaches the emission surface 62b. The infrared radiation incident on the outer peripheral surface of the main portion 62 (boundary surface between the outer peripheral surface and the medium outside the outer peripheral surface) at an incident angle θ (see FIG. 2) greater than or equal to the critical angle is totally reflected and guided to the emission surface 62b, and does not leak to the outside of the main portion 62. The infrared radiation incident at an incident angle θ less than the critical angle at least partially leaks to the outside of the main portion 62. However, since the reflective layer 69 is present, the infrared radiation can be reflected back toward the main portion 62. The infrared radiation that has reached the emission surface 62b is emitted downward from the emission surface 62b. As described above, the area of the emission surface 62b is less than those of the radiation surfaces of the metamaterial structure 30 (first and second radiation surfaces in this case). Therefore, the infrared radiation from the metamaterial structure 30 can be locally emitted downward from the emission surface 62b. In the present embodiment, the emission surface 62b has a rectangular shape. Therefore, the infrared radiation can be locally emitted directly downward from the emission surface 62b in a linear shape. Accordingly, for example, the infrared radiation can be emitted only toward a portion of an object or be efficiently emitted toward a small object. The infrared radiation emitted from the emission surface 62b includes a large amount of infrared radiation in a specific wavelength range. Therefore, an object having a relatively high absorptivity for the infrared radiation having the specific wavelength range can be efficiently irradiated with the infrared radiation and subjected to an infrared treatment, such as heating or drying of the object or a process of subjecting the object to a chemical reaction. The object may be, for example, a flat-plate-shaped or layer-shaped member that is conveyed in a direction perpendicular to the longitudinal direction (front-back direction in this example) of the emission surface 62b.

The infrared radiation device 10 according to the present embodiment that has been described above in detail is structured such that the infrared radiation in a specific wavelength range that has been selectively emitted from the metamaterial structure 30 is reflected by the reflecting portion 50 disposed around the radiation portion 11, reaches the incident surface 62a of the emitting portion 60, and is emitted from the emission surface 62b of the emitting portion 60. The area of the emission surface 62b is less than that of the radiation surface of the metamaterial structure 30 from which the infrared radiation is emitted. Therefore, the infrared radiation can be locally emitted from the emission surface 62b to the outside. The metamaterial structure 30 has planar radiation surface. Therefore, it is more difficult to locally emit the infrared radiation than, for example, in the case where the infrared radiation is emitted from a linear heating element. The infrared radiation device 10 according to the present embodiment includes the reflecting portion 50 and the emitting portion 60 so that the infrared radiation can be locally emitted to the outside despite the infrared radiation being emitted from planar radiation surface of the metamaterial structure 30.

The reflecting portion 50 has the interior space 53 in which the radiation portion 11 is disposed, and the interior space 53 does not communicate with the outside. Therefore, the infrared radiation emitted from the metamaterial structure 30 into the interior space 53 is prevented from leaking to the outside through, for example, clearances in the reflecting portion 50.

The emitting portion 60 guides the infrared radiation to the emission surface 62b by total reflection. Therefore, the infrared radiation emitted from the metamaterial structure 30 can be prevented from leaking to the outside through a region other than the emission surface 62b of the emitting portion 60. The emitting portion 60 includes the reflective layer 69 disposed on the outer peripheral surface of the main portion 62 that extends in the direction from the incident surface 62a to the emission surface 62b at least in the region 62d adjacent to the incident surface 62a. The reflective layer 69 reflects the infrared radiation toward the main portion 62. Therefore, even when there is infrared radiation that passes through the main portion 62 without total reflection, the reflective layer 69 prevents such infrared radiation from leaking to the outside. In particular, part of the infrared radiation is incident on the reflective surface of the main portion 62 (outer peripheral surface of the main portion 62 in this example) at the incident angle θ less than the critical angle in the region of the outer peripheral surface of the main portion 62 adjacent to the incident surface 62a, and easily leaks to the outside through the main portion 62 without being totally reflected. Therefore, leakage of the infrared radiation can be effectively prevented by arranging the reflective layer 69 in the region adjacent to the incident surface 62a.

The emitting portion 60 is connected to the reflecting portion 50 at a side adjacent to the incident surface 62a, and the region 62d in which the reflective layer 69 is disposed includes the connecting portion 62c of the outer peripheral surface of the main portion 62, the connecting portion 62c being connected to the reflecting portion 50. Although the infrared radiation easily leaks to the outside through the connecting portion 62c, the infrared radiation can be prevented from leaking to the outside since the reflective layer 69 is provided on the connecting portion 62c.

The metamaterial structure 30 includes the first metamaterial structure 30a that is disposed on the first-surface side (bottom-surface side) of the heating portion 12 and emits infrared radiation from the first radiation surface and the second metamaterial structure 30b that is disposed on the second-surface side (top-surface side) of the heating portion 12 and emits infrared radiation from the second radiation surface, the second-surface side being opposite to the first-surface side. The area of the emission surface 62b is less than the area of at least one of the first radiation surface and the second radiation surface. Accordingly, the radiation portion 11 is capable of selectively emitting infrared radiation in a specific wavelength range from both the first-surface side and the second-surface side of the radiation portion 11. Therefore, compared to the case in which the second metamaterial structure 30b is not provided on the second-surface side of the heating portion 12, emission of infrared radiation at unnecessary wavelengths other than the specific wavelength range from the second-surface side can be prevented, and loss of thermal energy from the second surface can be reduced.

The present invention is not limited to the above-described embodiment, and various embodiments are possible within the technical scope of the present invention.

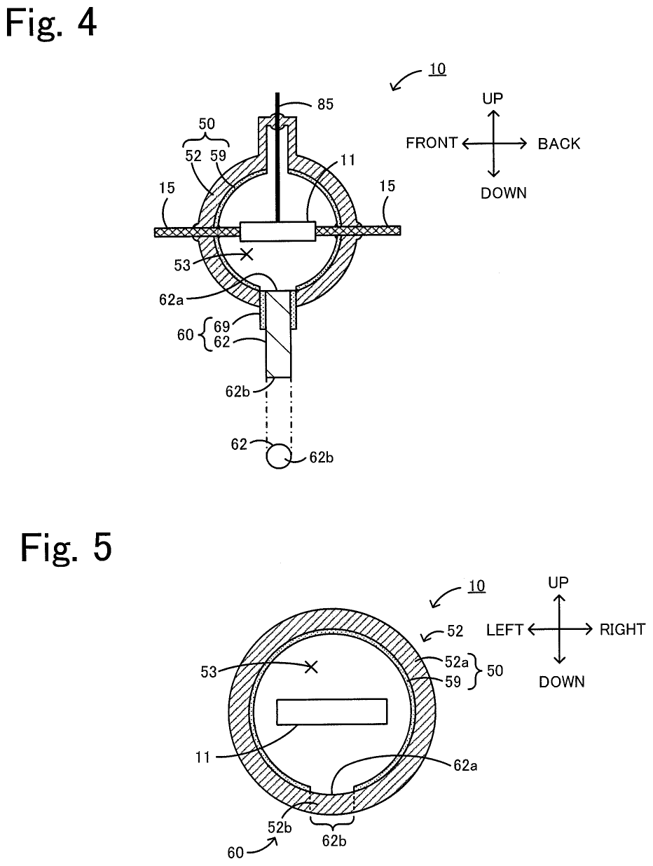

In the above-described embodiment, the emission surface 62b has a rectangular shape, and the infrared radiation device 10 locally emits infrared radiation toward a region directly below the emission surface 62b in a linear shape. However, the present invention is not limited to this. For example, the emission surface 62b may be formed such that the infrared radiation can be locally emitted, for example, in a circular or rectangular spot shape. FIG. 4 is a sectional view of an infrared radiation device 10 according to a modification. FIG. 4 also shows a bottom view of a main portion 62 at the bottom. The infrared radiation device 10 illustrated in FIG. 4 includes an outer tube 52 having a substantially spherical shape. Therefore, the sectional view of the outer tube 52 taken along the up-down and left-right directions is similar to FIG. 2. A radiation portion 11 has a substantially square shape in bottom view. The main portion 62 is a cylindrical rod-shaped member and includes a circular emission surface 62b. This infrared radiation device 10 is capable of locally emitting infrared radiation from the emission surface 62b in a circular spot shape. The main portion 62 may be a rectangular rod-shaped member.

In the above-described embodiment, the main portion 62 is rectangular-parallelepiped-shaped. However, the present invention is not limited to this. For example, the main portion 62 may have a curved portion between the incident surface 62a and the emission surface 62b. Alternatively, the main portion 62 may be tapered toward the emission surface 62b so that the area of the emission surface 62b is less than the area of the incident surface 62a. The incident surface 62a and the emission surface 62b are perpendicular to the up-down direction, but are not limited to this. For example, the incident surface 62a may be a concave surface, and the emission surface 62b may be a convex surface.

In the above-described embodiment, the reflecting portion 50 includes the outer tube 52 and the reflective layer 59. However, at least a portion of the outer tube 52 may serve as the reflective layer 59, and the outer tube 52 may be capable of reflecting the infrared radiation. For example, the material of the outer tube 52 may be ceramic (for example, alumina ceramic) or stainless steel. When the outer tube 52 reflects the infrared radiation, the inner peripheral surface of the outer tube 52 may be polished.

In the above-described embodiment, the reflective layer 69 is provided on the outer peripheral surface of the main portion 62 only in the region adjacent to the incident surface 62a. However, the present invention is not limited to this. The reflective layer 69 may instead be provided on the outer peripheral surface of the main portion 62 over the entire region thereof. The region 62d in which the reflective layer 69 is disposed includes the connecting portion 62c and a portion below the connecting portion 62c. However, the present invention is not limited to this. The region 62d may include only the connecting portion 62c. In other words, the reflective layer 69 may be provided only on the connecting portion 62c. Also, it is not necessary that the emitting portion 60 include the reflective layer 69.

According to the above-described embodiment, the pressure in the interior space 53 of the reflecting portion 50 is a normal pressure, that is, not reduced. However, the present invention is not limited to this, and the interior space 53 may be a space in which the pressure therein can be reduced. In such a case, by using the infrared radiation device 10 while the pressure in the interior space 53 is reduced, the amount of convective heat transfer from the radiation portion 11 to the interior space 53 is less than that when, for example, the pressure in the interior space 53 is a normal pressure, and the convective loss can be reduced. As a result, the energy efficiency of the infrared radiation device 10 can be increased. In addition, when the pressure in the interior space 53 is reduced, an increase in the temperature of the reflecting portion 50 due to convective heat transfer can be reduced. Therefore, the reflecting portion 50 is prevented from serving as a secondary radiator and emitting infrared radiation of unnecessary wavelengths. When the pressure in the interior space 53 can be reduced, the interior space 53 may be set to a reduced-pressure atmosphere by a vacuum pump through the suction hole in the outer tube 52 that can be opened and closed when the infrared radiation device 10 is used. Alternatively, when the infrared radiation device 10 is manufactured, the interior space 53 may be sealed from the outside while the pressure therein is set to a reduced-pressure atmosphere. The pressure in the interior space 53 may be, for example, 100 Pa or less, or vacuum (for example, 10 Pa or less). The pressure in the interior space 53 may be reduced to, for example, a pressure greater than or equal to 0.01 Pa.

In the above-described embodiment, the reflecting portion 50 may be cooled (for example, water-cooled or air-cooled) from the outside. In such a case, even when part of the infrared radiation is absorbed by the reflecting portion 50, an increase in the temperature of the reflecting portion 50 can be reduced, and the reflecting portion 50 can be prevented from serving as a secondary radiator that emits infrared radiation with unnecessary wavelengths.

Although the infrared radiation is totally reflected by the outer peripheral surface of the main portion 62 of the emitting portion 60 in the above-described embodiment, the present invention is not limited to this. For example, the main portion 62 may include a high-refractive-index material having an incident surface and an emission surface and a low-refractive-index material that has a refractive index lower than that of the high-refractive-index material and that surrounds the outer peripheral surface of the high-refractive-index material (for example, front, back, left, and right surfaces in FIGS. 1 and 2). In such a case, the main portion 62 is capable of totally reflecting infrared radiation at the boundary surface between the high-refractive-index material and the low-refractive-index material. Also, the emitting portion 60 may be configured such that the infrared radiation is guided to the emission surface 62b by reflection instead of total reflection. For example, the infrared radiation may be reflected by a reflective layer surrounding the outer peripheral surface of the main portion 62 instead of being totally reflected by the main portion 62.

In the above-described embodiment, the interior space 53 does not communicate with the outside. However, the present invention is not limited to this. For example, the reflecting portion 50 and the emitting portion 60 may have a clearance therebetween, and the reflecting portion 50 may have a hole or clearance in a region other than the region where the emitting portion 60 is present. However, preferably, the interior space 53 does not communicate with the outside so that leakage of the infrared radiation to the outside can be prevented. In addition, the emitting portion 60 may have a through hole through which the interior space 53 communicates with the outside. For example, the main portion 62 of the emitting portion 60 may have a through hole that extends through the main portion 62 in the vertical direction, and the infrared radiation may be reflected by the inner peripheral surface of the through hole and guided to the emission surface 62b.

In the above-described embodiment, the emitting portion 60 guides the infrared radiation from the incident surface 62a to the emission surface 62b by total reflection. However, the present invention is not limited to this. For example, an infrared radiation device 10 according to a modification illustrated in FIG. 5 may be provided. The infrared radiation device 10 illustrated in FIG. 5 includes an outer tube 52 that does not have an opening, and an interior space 53 is sealed from the outside by the outer tube 52. A first portion 52a of the outer tube 52 having a reflective layer 59 on the inner peripheral surface thereof and the reflective layer 59 constitute a reflecting portion 50. A second portion 52b of the outer tube 52 on which the reflective layer 59 is not provided on the inner peripheral surface thereof constitutes an emitting portion 60. The surface of the second portion 52b facing the interior space 53 serves as an incident surface 62a, and the outer surface of the second portion 52b serves as an emission surface 62b. The emission surface 62b is a region of the second portion 52b that is directly below the incident surface 62a, and the area of the incident surface 62a is the same as the area of the emission surface 62b. The area of the emission surface 62b is less than that of the radiation surface of the metamaterial structure 30 from which the infrared radiation is emitted. According to this infrared radiation device 10, the infrared radiation emitted from the radiation portion 11 and reflected by the reflecting portion 50 enters the emitting portion 60 (second portion 52b in this example) through the incident surface 62a and is emitted to the outside through the emission surface 62b. Since the area of the emission surface 62b is less than that of the radiation surface of the metamaterial structure 30 from which the infrared radiation is emitted, the infrared radiation can be locally emitted to the outside of the emission surface 62b. Even when the emitting portion 60 simply transmits the infrared radiation instead of guiding the infrared radiation as in the infrared radiation device 10 illustrated in FIG. 5, the infrared radiation from the metamaterial structure 30 can be locally emitted to the outside. However, in this case, the infrared radiation is more easily emitted from a peripheral region around the emission surface 62b compared to, for example, the infrared radiation device 10 illustrated in FIGS. 1 and 2. In other words, part of the infrared radiation easily leaks to the outside through a region other than the emission surface 62b.

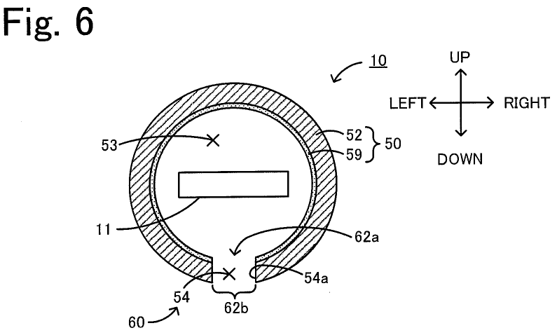

In the above-described embodiment, the emitting portion 60 includes the main portion 62 and the reflective layer 69 disposed in a hole formed in the reflecting portion 50. However, the present invention is not limited to this, and the emitting portion 60 may be a space. For example, an infrared radiation device 10 according to a modification illustrated in FIG. 6 may be provided. The infrared radiation device 10 illustrated in FIG. 6 does not include the main portion 62 and the reflective layer 69 illustrated in FIGS. 1 and 2, and the space in a hole 54 formed in the lower section of a reflecting portion 50 serves as an emitting portion 60. An opening portion (open surface) of the hole 54 that faces the interior space 53 serves as an incident surface 62a, and an opening portion (open surface) of the hole 54 that faces outward serves as an emission surface 62b. The area of the emission surface 62b is less than that of the radiation surface of the metamaterial structure 30 from which the infrared radiation is emitted. According to this infrared radiation device 10, the infrared radiation emitted from the radiation portion 11 and reflected by the reflecting portion 50 enters the emitting portion 60 (hole 54 in this example) through the incident surface 62a and is emitted to the outside through the emission surface 62b. Since the area of the emission surface 62b is less than that of the radiation surface of the metamaterial structure 30 from which the infrared radiation is emitted, the infrared radiation can be locally emitted to the outside of the emission surface 62b. In the infrared radiation device 10 illustrated in FIG. 6, the hole 54 preferably has an inner peripheral surface 54a capable of reflecting the infrared radiation from the metamaterial structure 30. In such a case, the emitting portion 60 is capable of guiding the infrared radiation from the incident surface 62a to the emission surface 62b by reflection. The inner peripheral surface 54a of the hole 54 is preferably capable of totally reflecting the infrared reflection from the metamaterial structure 30. For example, the outer tube 52 may be made of a material capable of reflecting the infrared radiation emitted from the metamaterial structure 30, or reflective layers may be provided on the inner peripheral surface 54a, so that the emitting portion 60 is capable of guiding the infrared radiation from the incident surface 62a to the emission surface 62b by reflection.

In the above-described embodiment, the metamaterial structure 30 includes the first metamaterial structure 30a and the second metamaterial structure 30b. However, one of the first metamaterial structure 30a and the second metamaterial structure 30b may be omitted.

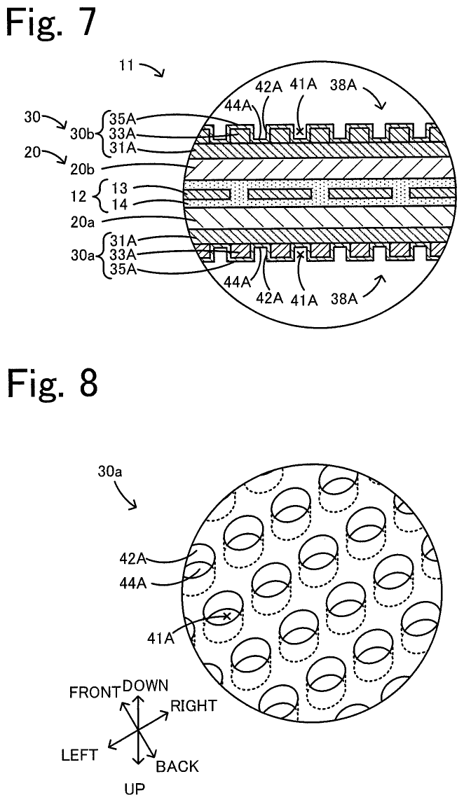

For example, in the above-described embodiment, the metamaterial structure 30 includes the first conductor layer 31, the dielectric layer 33, and the second conductor layer 35. In other words, the metamaterial structure 30 has the MIM structure. However, the present invention is not limited to this. The metamaterial structure 30 may be any structure that is capable of emitting infrared radiation having a peak wavelength of a non-Planck distribution when thermal energy is supplied thereto from the heating portion 12. For example, the metamaterial structure may be configured as a microcavity body in which a plurality of microcavities are formed. FIG. 7 is a partial sectional view of a radiation portion 11 according to a modification. FIG. 8 is a partial bottom perspective view of a first metamaterial structure 30a according to a modification. The first and second metamaterial structures 30a and 30b of the radiation portion 11 according to the modification each include a plurality of microcavities 41A that have a conductor layer 35A at least on surfaces thereof (side surfaces 42A and bottom surfaces 44A in this modification) and that form a periodic structure that is periodic in the front-back and left-right directions. A radiation surface 38A, which is the bottom surface of the first metamaterial structure 30a, is a first radiation surface, and a radiation surface 38A, which is a top surface of the second metamaterial structure 30b, is a second radiation surface.

The first metamaterial structure 30a and the second metamaterial structure 30b have identical structural elements, and are symmetrical to each other about a plane perpendicular to the up-down direction. Therefore, the first metamaterial structure 30a will be described in detail. Components of the second metamaterial structure 30b are denoted by the same reference numerals in FIG. 7, and detailed description thereof will be omitted. The first metamaterial structure 30a includes a main body layer 31A, a recessed layer 33A, and a conductor layer 35A in that order in a downward direction from the heating portion 12 of the radiation portion 11. The main body layer 31A is composed of, for example, a glass substrate. The recessed layer 33A is made of, for example, a resin or an inorganic material, such as ceramic or glass. The recessed layer 33A is formed on the bottom surface of the main body layer 31A, and has cylindrical recesses formed therein. The recessed layer 33A may be made of the same material as the second conductor layer 35. The conductor layer 35A is provided on a surface (bottom surface) of the first metamaterial structure 30a and covers surfaces (bottom and side surfaces) of the recessed layer 33A and the bottom surface of the main body layer 31A (regions where the recessed layer 33A is not provided). The conductor layer 35A is composed of a conductor, and the material thereof may be, for example, a metal, such as gold or nickel, or a conductive resin. The microcavities 41A are substantially cylindrical spaces that are open at the bottom and surrounded by the side surfaces 42A of the conductor layer 35A (portions that cover the side surfaces of the recessed layer 33A) and the bottom surfaces 44A of the conductor layer 35A (portions that cover the bottom surface of the main body layer 31A). As illustrated in FIG. 8, the microcavities 41A are arranged in the front-back and left-right directions. The bottom surface of the first metamaterial structure 30a serves as a radiation surface 38A from which the infrared radiation is emitted toward an object. More specifically, when the first metamaterial structure 30a absorbs the energy emitted from the heating portion 12, infrared radiation having a high intensity in a specific wavelength is emitted toward the object disposed below the radiation surface 38A due to resonance between incident and reflected waves in the spaces defined by the bottom surfaces 44A and the side surfaces 42A. Thus, the first metamaterial structure 30a is capable of emitting infrared radiation having a peak wavelength of a non-Planck distribution. The radiation characteristics of the first metamaterial structure 30a can be adjusted by adjusting the diameter and depth of each of the cylindrical microcavities 41A. The shape of the microcavities 41A is not limited to a cylindrical shape, and may instead be a prismatic shape. The depth of the microcavities 41A may be, for example, greater than or equal to 1.5 μm and less than or equal to 10 μm. The first metamaterial structure 30a illustrated in FIGS. 7 and 8 may be formed by, for example, the following method. First, the recessed layer 33A is formed on the bottom surface of the main body layer 31A by a commonly known nanoimprinting process. Then, the conductor layer 35A is formed to cover the surfaces of the recessed layer 33A and the main body layer 31A by, for example, sputtering. One of the first and second metamaterial structures 30a and 30b may have an MIM structure while the other has microcavities.

The present application claims priority on the basis of the Japanese Patent Application No. 2018-140387 filed on Jul. 26, 2018, the entire contents of which are incorporated herein by reference.

What is claimed is:

1. An infrared radiation device comprising:
a radiation portion including a heating portion and metamaterial structure capable of emitting infrared radiation having a peak wavelength of a non-Planck distribution from a radiation surface when thermal energy is supplied from the heating portion;
a reflecting portion that surrounds the radiation portion and reflects the infrared radiation emitted from the metamaterial structure; and
an emitting portion having an incident surface on which the infrared radiation reflected by the reflecting portion is incident and an emission surface through which infrared radiation incident on the incident surface is emitted to outside, the emission surface having an area less than an area of the radiation surface.

2. The infrared radiation device according to claim 1,
wherein the reflecting portion has an interior space therein, the radiation portion being disposed in the interior space, and
wherein the interior space does not communicate with the outside.

3. The infrared radiation device according to claim 2,
wherein a pressure in the interior space is capable of being reduced.

4. The infrared radiation device according to claim 1,
wherein the emitting portion guides the infrared radiation to the emission surface by total reflection.

5. The infrared radiation device according to claim 1,
wherein the emitting portion includes a main portion and a reflective layer, the main portion having the incident surface and the emission surface and guiding the infrared radiation to the emission surface by total reflection, the reflective layer being disposed on an outer peripheral surface of the main portion extending in a direction from the incident surface to the emission surface at least in a region adjacent to the incident surface and reflecting the infrared radiation toward the main portion.

6. The infrared radiation device according to claim 5,
wherein the emitting portion is connected to the reflecting portion at a side of the emitting portion adjacent to the incident surface, and
wherein the region in which the reflective layer is disposed includes a connecting portion of the outer peripheral surface of the main portion, the connecting portion being connected to the reflecting portion.

7. The infrared radiation device according to claim 1,
wherein the metamaterial structure includes a first metamaterial structure that is disposed on a first-surface side of the heating portion and emits the infrared radiation from a first radiation surface and a second metamaterial structure that is disposed on a second-surface side of the heating portion and emits the infrared radiation from a second radiation surface, the second-surface side being opposite to the first-surface side, and
wherein the emission surface has an area less than an area of at least one of the first radiation surface and the second radiation surface.

8. The infrared radiation device according to claim 1,
wherein the metamaterial structure includes a first conductor layer, a dielectric layer joined to the first conductor layer, and a second conductor layer, which are arranged in that order from the heating portion, the second conductor layer including a plurality of individual conductor layers that are each joined to the dielectric layer and that are periodically arranged with gaps therebetween.

9. The infrared radiation device according to claim 1,
wherein the metamaterial structure has a plurality of microcavities, at least surfaces of which are formed of a conductor and which are periodically arranged with gaps therebetween.
